(19) United States
(12) Patent Application Publication
(10) Pub. No.: US 2002/0113137 A1
(43) Pub. Date: Aug. 22, 2002

(54) Method of manufacturing a spray boom

(75) Inventor: Alain Guesdon, Noisy Sur Ecole (FR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KUHN-NODET S. A., MONTEREAU (FR)

(21) Appl. No.: 10/051,041

(22) Filed: Jan. 22, 2002

(30) Foreign Application Priority Data
Feb. 9, 2001 (FR) 01 02039

(51) Int. Cl. B05B 17/00; B05B 3/14

(52) U.S. Cl. 239/1; 239/159; 239/161; 239/167

(57) ABSTRACT

The present invention relates to a method for manufacturing a spray boom. The method comprises the steps of forming flat two ladders, each ladder consisting of an upper beam connected to a lower beam by girders, producing lower crossbeams, assembling the two ladders and the lower crossbeams to form a three-dimensional structure. The present invention advantageously makes it possible to reduce the cost of manufacturing a spray boom.

### BACKGROUND OF THE INVENTION

1. Field of the Invention

The present invention relates to the general technical field of agricultural machinery and relates more specifically to a method of manufacturing a spray boom.

2. Discussion of the Background

In a way known to those skilled in the art, an agricultural sprayer comprises a boom intended to support a multitude of nozzles. During work, said boom is arranged at right angles to a direction of forward travel and on each side of said sprayer. Said nozzles, for their part, are intended to spray a treatment liquid on to the ground or onto plants. To increase the width of the strip of land treated in one pass, agricultural sprayers are currently equipped with booms which may be as much 30 meters long.

In order to withstand the stresses generated by such dimensions, spray booms are generally made by a latticework structure. Viewed in cross section, this latticework structure has a substantially triangular shape, one of the vertices of which points upward. Said nozzles are advantageously connected to the base of this triangular shape.

Said latticework structure is generally made up of an upper beam and of two lower beams, which beams are arranged at the three vertices of said triangular shape. Said latticework structure also comprises girders which zigzag between the upper beam and the lower beams. Said girders thus form the sides of said triangular shape. For its part, the base of the triangular shape is produced by crossbeams connecting the two lower beams.

The manufacture of this latticework structure therefore entails positioning the three main beams in space and then connecting them together using the girders and crossbeams. Such positioning of the three beams is relatively difficult to achieve.

In addition, because of their position with respect to said main beams and in order to make them easier to assemble by welding, said girders need to have their ends cut in a particularly complex way. Specifically, the cutting plane of said ends needs to be inclined in two directions with respect to a plane perpendicular to the longitudinal axis of said girder.

### SUMMARY OF THE INVENTION

The object of the present invention consists in overcoming these drawbacks of the prior art by proposing a method of manufacture of a spray boom which is less complicated and therefore less expensive.

To achieve this, the method of the present invention comprises the steps of:

forming flat two ladders, each ladder consisting of an upper beam connected to a lower beam by girders,

producing lower crossbeams,

assembling the two ladders and the lower crossbeams to form a three-dimensional structure.

With the method of manufacture of the present invention, the beams and girders are advantageously arranged in one plane. In addition, the plane of section of the ends of said girders is inclined in at most one direction with respect to a plane perpendicular to the longitudinal axis of said girder.

### BRIEF DESCRIPTION OF THE DRAWINGS

Other features of the invention, to be considered separately or in any possible combination, will become further apparent in the following description of a nonlimiting exemplary embodiment of the invention, which embodiment is depicted in the appended drawings in which:

FIG. 1 depicts a plan view of a ladder according to the present invention,

FIG. 2 depicts another view of said ladder, in the direction of the arrow II defined in FIG. 1,

FIG. 3 depicts, viewed in the direction of arrow III defined in FIG. 1, a structure obtained by the method of the present invention, and

FIG. 4 depicts a view of said structure in the direction of arrow IV defined in FIG. 3.

### DESCRIPTION OF THE PREFERRED EMBODIMENT

One of the steps in the method of manufacture of the present invention consists in producing two ladders 1; 2. Said ladder 1; 2 comprises an upper beam 3 and a lower beam 4. Said upper 3 and lower 4 beams are joined together by girders 5. As can be seen in FIG. 2, said beams 3, 4 and said girders 5 are advantageously arranged in one and the same plane. As a result, a ladder 1; 2 such as this can be assembled very easily by laying the various elements 3, 4, 5 of which said ladder 1; 2 is made out flat.

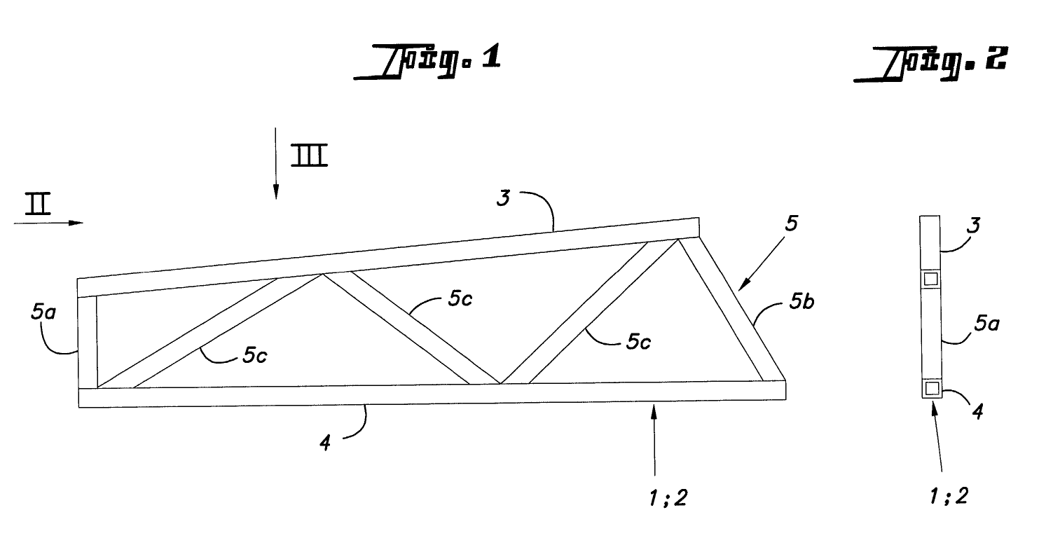

In the embodiment depicted in FIG. 1, a first end of said upper beam 3 is connected to a first end of said lower beam 4 by a first end girder 5a. Likewise, a second end of said upper beam 3 is connected to a second end of said lower beam 4 by a second end girder 5b. Advantageously, said first end girder 5a and said lower beam 4 at least substantially make an angle of 90 degrees.

In the embodiment depicted in FIG. 1, said ladder 1; 2 additionally comprises three other girders 5c zigzagging between said upper beam 3 and said lower beam 4. A zigzagging configuration such as this advantageously increases the rigidity of said ladder 1; 2.

As can be seen in FIG. 1, each end of said girders 5 is cut in a respective plane. Said respective plane is inclined in at most one direction with respect to a plane perpendicular to the longitudinal axis of the corresponding girder 5. Said cuts are therefore far easier to make.

In order to combine lightness of weight with robustness, said beams 3, 4 and said girders 5 are advantageously obtained from a hollow section piece. In the embodiment depicted in the figures, said hollow section piece is a square tube. As the square tube is commonly used in mechanical engineering, its purchase price is relatively low. This again reduces the cost of manufacture of said structure.

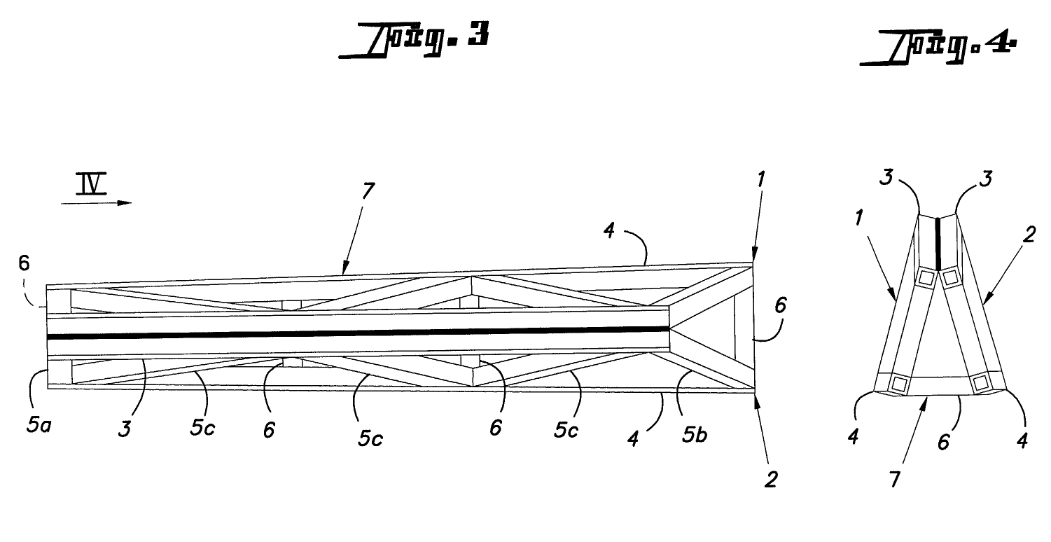

Another step in the method of manufacture of the present invention consists in assembling the two ladders 1; 2 so as to form a three-dimensional structure 7. Indeed, as can be seen in FIGS. 3 and 4, said ladders 1; 2 are arranged in such a way that said respective upper beams 3 are side to side. For their part, said lower beams 4 are held apart by lower crossbeams 6. Thus, viewed according to FIG. 4, said structure 7 has a substantially triangular cross section.

As a preference, said ladder 1 and said ladder 2 are at least substantially identical. Thus the cross section of said three-dimensional structure 7 defines a substantially isosceles triangle.

In the exemplary embodiment depicted in FIG. 3, said structure 7 comprises four lower crossbeams 6 arranged transversely to said lower beams 4. Said lower crossbeams 6 are advantageously mutually parallel.

Spray booms of relatively modest length can be produced by means of a single structure 7. In such a case, said upper beams 3 and said lower beams 4 are advantageously mutually parallel. As a result, the cross section of said structure 7 is uniform along the entire length of said boom. In addition, said lower crossbeams 6 are thereby simpler to cut.

In contrast, booms of relatively long length are generally made up of several sections which are articulated. In a way known to those skilled in the art, these articulated sections make it possible in particular for said boom to be folded for transport. At least one of said sections is advantageously produced by means of said structure 7. In such a case and as a preference, said upper beams 3 and said lower beams 4 are convergent. The cross section of said structure 7 therefore varies along said boom. More specifically, said cross section decreases gradually as one end of said boom is neared.

The method of manufacture, the structure 7 and the boom which have just been described, are merely one exemplary embodiment and one example of use which has not in any way to be taken as restricting the field of protection defined by the claims which follow.

What is claimed as new and desired to be secured by Letters Patent of the United States is:

1. Method for manufacturing a spray boom, wherein said method comprises the steps of:
forming flat two ladders, each ladder consisting of an upper beam connected to a lower beam by girders,
producing lower crossbeams,
assembling the two ladders and the lower crossbeams to form a three-dimensional structure.

2. Method of manufacture as claimed in claim 1, wherein said three-dimensional structure has a triangular cross section.

3. Method of manufacture as claimed in claim 1, wherein respective upper beams of said ladders are side to side.

4. Method of manufacture as claimed in claim 1, wherein respective lower beams of said ladders are held apart by said lower crossbeams.

5. Method of manufacture as claimed in claim 1, wherein at least one of said girders and said lower beam of one of said ladders make an angle of 90 degrees.

6. Method of manufacture as claimed in claim 1, wherein at least one of said girders and said upper beam of one of said ladders make an angle of 90 degrees.

7. Method of manufacture as claimed in claim 1, wherein said upper beams and said lower beams of said three-dimensional structure are convergent.

8. Method of manufacture as claimed in claim 1, wherein said ladders are identical.

9. Method of manufacture as claimed in claim 1, wherein said spray boom comprises a single section, which section is produced by said three-dimensional structure.

10. Method of manufacture as claimed in claim 1, wherein said spray boom is produced by at least two articulated sections, at least one of said sections being produced by said three-dimensional structure.

11. Agricultural spray boom which is manufactured by a method as claimed in claim 1.

12. Agricultural sprayer which comprises at least one spray boom, as claimed in claim 11.
